(19) United States
(12) Patent Application Publication
(10) Pub. No.: US 2008/0150907 A1
(43) Pub. Date: Jun. 26, 2008

(54) TOUCH SCREEN-ENABLED MOBILE TERMINAL AND FUNCTION DISPLAY METHOD FOR THE SAME

(75) Inventors: Chan Woo Park, Seoul (KR); Jong Pil Shin, Seoul (KR); Myeong Lo Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/957,998

(22) Filed: Dec. 17, 2007

(30) Foreign Application Priority Data
Dec. 20, 2006 (KR) 2006-0130552

(51) Int. Cl. G06F 3/041; H04Q 7/32; G06F 3/048

(52) U.S. Cl. 345/173; 715/765; 715/773; 455/566

(57) ABSTRACT

A touch screen-enabled mobile terminal and function display method for the same is disclosed. The function display method includes selecting a menu of the mobile terminal; and displaying a user interface window corresponding to the selected menu on a touch screen. As a result, the user can use various functions of the mobile terminal through a dual display feature.

### PRIORITY

This application claims priority under 35 U.S.C. §119 to an application entitled “TOUCH SCREEN-ENABLED MOBILE TERMINAL AND FUNCTION DISPLAY METHOD FOR THE SAME” filed in the Korean Intellectual Property Office on Dec. 20, 2006 and assigned Serial No. 2006-0130552, the contents of which are incorporated herein by reference.

### BACKGROUND OF THE INVENTION

1. Field of the Invention

The present invention relates generally to a mobile terminal having a touch screen and, more particularly, to a mobile terminal having a touch screen and function display method for the same, wherein various user interface windows corresponding to function-related menus of the mobile terminal are displayed on the touch screen.

2. Description of the Related Art

Advances in information and communication technologies have led to the popularization of mobile terminals. In addition to basic communication functions related to phone calls and text messages, advanced mobile terminals support supplementary functions such as music playing and photographing.

To use a mobile terminal supporting various functions, the user may have to input an increased number of control signals through a sophisticated menu structure. To control various functions, buttons of input units in mobile terminals tend to increase in number. Input/output means such as touch screens capable of performing both input and display functions may be used to decrease the number of necessary buttons.

However, for received text messages, operations such as ‘select’, ‘view’, ‘reply’, ‘save’ and ‘delete’ may still require a number of input control signals through the input unit. Controlling music files for music playing may also require a number of input control signals through the input unit.

### SUMMARY OF THE INVENTION

The present invention has been made in view of the above problems, and the present invention provides a mobile terminal having a touch screen and function display method for the same, wherein user interface windows related to message handling and music playing are displayed on the touch screen.

The present invention also provides a mobile terminal having a touch screen and function display method for the same, wherein user interface windows related to individual menus are displayed on the touch screen to enable immediate input of necessary control signals.

In accordance with an exemplary embodiment of the present invention, there is provided a function display method for a mobile terminal having a touch screen as an input/output means, including selecting a menu of the mobile terminal; and displaying a user interface window corresponding to the selected menu on the touch screen.

In accordance with another exemplary embodiment of the present invention, there is provided a mobile terminal including a memory unit for storing at least one user interface window; an input unit, comprising a touch screen, for selecting a menu of the mobile terminal; and a control unit for extracting a user interface window corresponding to the selected menu from the memory unit, and displaying the extracted user interface window on the touch screen.

### BRIEF DESCRIPTION OF THE DRAWINGS

The above and other objects, features and advantages of the present invention will be more apparent from the following detailed description in conjunction with the accompanying drawings, in which:

FIG. 1 illustrates a configuration of a mobile terminal having a touch screen according to an exemplary embodiment of the present invention;

FIG. 2 is a flow chart illustrating a function display method for the mobile terminal of FIG. 1 according to another exemplary embodiment of the present invention;

FIG. 3 is a flow chart illustrating a music playing procedure in the method of FIG. 2;

FIG. 4 is a display representation for message handling in the mobile terminal of FIG. 1; and

FIGS. 5A to 5D are display representations for music playing in the mobile terminal of FIG. 1.

### DETAILED DESCRIPTION OF EXEMPLARY EMBODIMENTS

Hereinafter, exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail.

The mobile terminal of the present invention is a touch screen-enabled terminal for user convenience, and may be any information and communication appliance or multimedia appliance, such as a mobile communication terminal, mobile phone, Personal Digital Assistant (PDA), and smart phone.

For the purpose of description, states and functions related to a message handling menu and music playing menu are displayed on the touch screen. States and functions related to all menus of the mobile terminal may also be displayed on the touch screen.

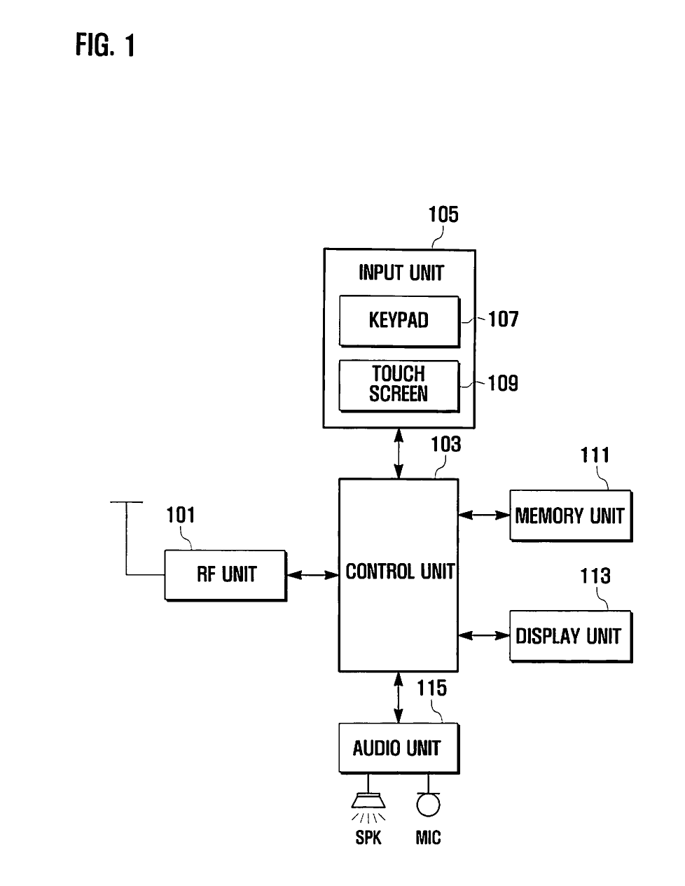

FIG. 1 illustrates a configuration of a mobile terminal having a touch screen according to an exemplary embodiment of the present invention.

Referring to FIG. 1, the mobile terminal includes a Radio Frequency (RF) unit 101, control unit 103, input unit 105, keypad 107, touch screen 109, memory unit 111, display unit 113, and audio unit 115.

The RF unit 101 performs general wireless communication between the mobile terminal and a mobile communication network. For example, the RF unit 101 sends and receives voice calls, text messages, and multimedia messages through the mobile communication network.

The control unit 103 controls the overall operation of the mobile terminal. The control unit 103 encodes and modulates a signal to be transmitted through the RF unit 101, and demodulates and decodes a signal received through the RF unit 101. The control unit 103 may include a MOdulator/DEModulator (modem) and a COder/DECoder (codec). In particular, in response to a control signal from the input unit 105, the control unit 103 controls the display unit 113 to display a different screen of visual objects, and also controls the touch screen 109 to display a corresponding user interface window. For an idle screen, the control unit 103 controls the touch screen 109 to display a user interface window having alphanumeric keys.

The input unit 105 receives a control signal for the mobile terminal from the user, and sends the received control signal to the control unit 103. Thereto, the input unit 105 includes the keypad 107 and touch screen 109.

The keypad 107 includes function keys, such as the ‘on/off’ key, ‘call’ key, ‘end’ key, ‘menu’ key, ‘ok’ key, ‘cancel’ key, ‘Bluetooth,’ key, ‘phonebook’ key, and ‘camera’ key. The keypad 107 may be implemented using a touch screen.

The touch screen 109 displays a user interface window corresponding to a selected function or menu of the mobile terminal. For example, the touch screen 109 displays a user interface window having alphanumeric keys in accordance with the idle screen. The touch screen 109 also displays a user interface window having message handling keys in accordance with viewing of a received message stored in the memory unit 111. In accordance with music listening, the touch screen 109 displays a user interface window having play control keys, a user interface window having background effect selection keys, and a user interface window having musical instrument images.

The memory unit 111 stores setting information and menus for the operation of the mobile terminal, under the control of the control unit 103. The memory unit 111 stores user interface windows corresponding to selectable functions or menus. For example, the memory unit 111 stores user interface windows for message viewing and music listening. For music listening, the memory unit 111 stores music data, background effect data, and a database table having mappings between musical instruments and music tones.

The display unit 113 displays operation states and results in the mobile terminal, and various information under the control of the control unit 103. The display unit 113 may include a panel of Liquid Crystal Display (LCD) devices, or a panel of Organic Light Emitting Diodes (OLED).

The audio unit 115 converts an analog audio signal from a microphone MIC into a digital signal, and also converts a digital audio signal from the control unit 103 into an analog audio signal for reproduction through a speaker SPK.

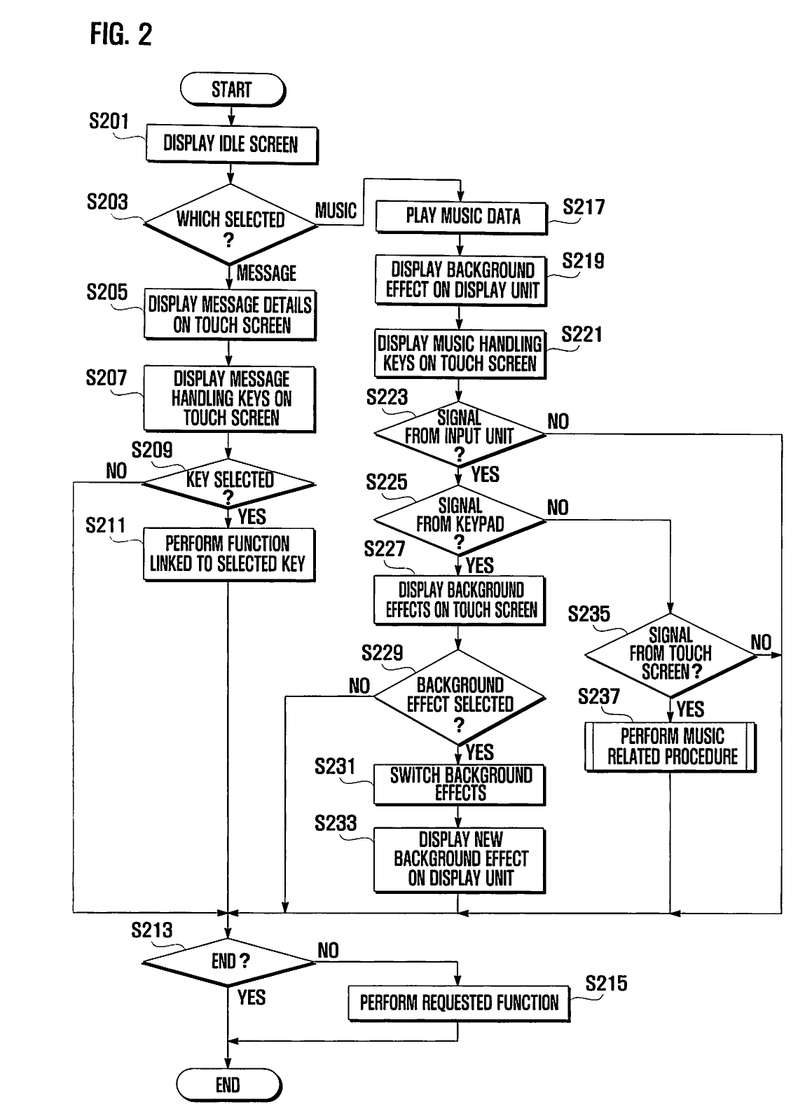

FIG. 2 is a flow chart illustrating a function display method for the mobile terminal of FIG. 1 according to another exemplary embodiment of the present invention.

Referring to FIG. 2, the control unit 103 of the mobile terminal displays the idle screen in an idle mode in step S201. Upon reception of a selection signal from the input unit 105, the control unit 103 determines which of a ‘message’ menu and ‘music’ menu is selected in step S203.

If the ‘message’ menu is selected, the control unit 103 controls the display unit 113 to display a list of received messages and to place a highlight on a message. The control unit 103 also controls the touch screen 109 to display message details of the highlighted message (step S205). Message details may include a message body, the date and time of reception, and a serial number. The control unit 103 controls the touch screen 109 to display a user interface window having a ‘reply’ key, ‘forward’ key, ‘delete’ key, ‘save’ key, and ‘protect’ key together with the message details in step S207. When a selection signal for a key is received from the input unit 105 in step S209, the control unit 103 performs a function associated with the selected key in step S211.

When an ‘end’ signal is received from the input unit 105 in step S213, the control unit 103 controls the touch screen 109 to display a user interface window having alphanumeric keys. When a signal other than an ‘end’ signal is received from the input unit 105 at step S213, the control unit 103 performs a requested function in step S215.

If the ‘music’ menu is selected at step S203, the control unit 103 enters into a music play mode, and controls the audio unit 115 to output selected music data through the speaker SPK in step S217. During playing of the music data, the control unit 103 displays a preset background effect on the display unit 113 in step S219. The control unit 103 controls the touch screen 109 to display a user interface window having music handling keys in step S221.

When an input signal is received from the input unit 105 in step S223, the control unit 103 determines whether the input signal is from the keypad 107 in step S225.

If the input signal is from the keypad 107 for background effect control, the control unit 103 controls the touch screen 109 to display available background effects in step S227. When a new background effect is selected in step S229, the control unit 103 performs background effect switching in step S231, and controls the display unit 113 to display the new background effect step S233.

When an ‘end’ signal is received from the input unit 105 in step S213, the control unit 103 controls the touch screen 109 to display the user interface window having alphanumeric keys. When a signal other than an ‘end’ signal is received from the input unit 105 at step S213, the control unit 103 performs a requested function in step S215.

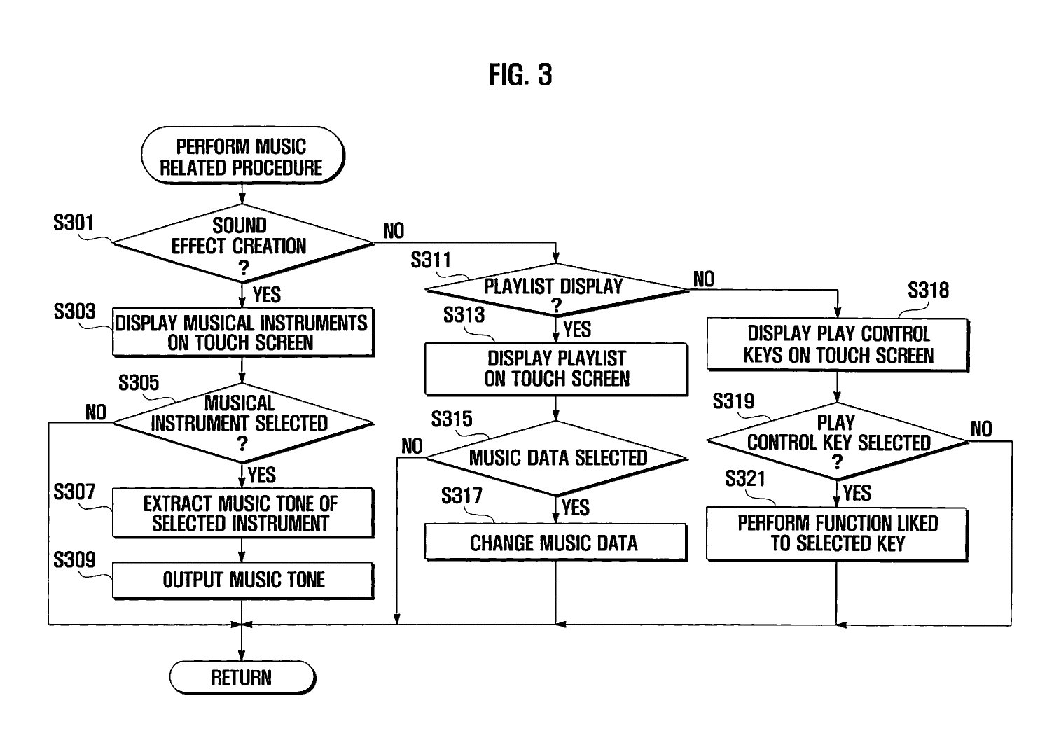

If the input signal is not from the keypad 107 at step S225, the control unit 103 determines whether the input signal is from the touch screen 109 in step S235. If the input signal is from the touch screen 109, the control unit 103 performs a music playing procedure in step S237, which is described in connection with FIG. 3.

FIG. 3 is a flow chart illustrating a music playing procedure in the method of FIG. 2.

Referring to FIG. 3, in response to an input signal from the touch screen 109, the control unit 103 checks whether the input signal is for a sound effect in step S301.

If the input signal is for a sound effect, the control unit 103 controls the touch screen 109 to display a user interface window having images of musical instruments in step S303. When a musical instrument image is selected in step S305, the control unit 103 extracts a music tone corresponding to the selected musical instrument image in step S307, and controls the audio unit 115 to output the extracted music tone through the speaker SPK together with music data being played in step S309.

If the input signal is not for a sound effect, the control unit 103 checks whether the input signal is for playlist display in step S311.

If the input signal is for playlist display, the control unit 103 controls the touch screen 109 to display a list of music data stored in the memory unit 111 in step S313. When new music data in the list is selected in step S315, the control unit 103 plays the new music data instead of music data being played in step S317.

If the input signal is not for playlist display, the control unit 103 controls the touch screen 109 to display a user interface window having play control keys in step S318. When a play control key is selected in step S319, the control unit 103 performs a function linked to the selected play control key in step S321. The play control keys may be linked to functions such as ‘section repeat’, ‘pause’, ‘previous’ and ‘next’.

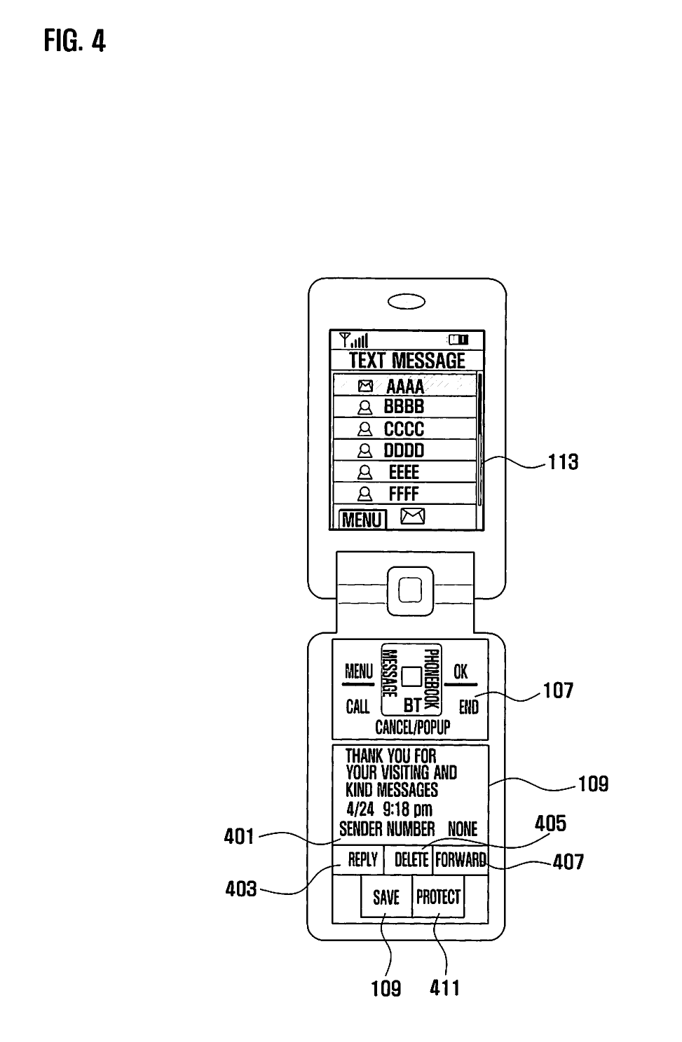

FIG. 4 is a display representation for message handling in the mobile terminal of FIG. 1.

In FIG. 4, the display unit 113 displays a list of received messages (senders, sender phone numbers, titles etc), and the touch screen 109 displays details of a selected message in a region 401 and a user interface window having message handling keys such as a ‘reply’ key 403, ‘delete’ key 405, ‘forward’ key 407, ‘save’ key 409, and ‘protect’ key 411.

When the user selects the ‘reply’ key 403, the control unit 103 controls the display unit 113 to display a message reply window, and also controls the touch screen 109 to display a user interface window having alphanumeric keys.

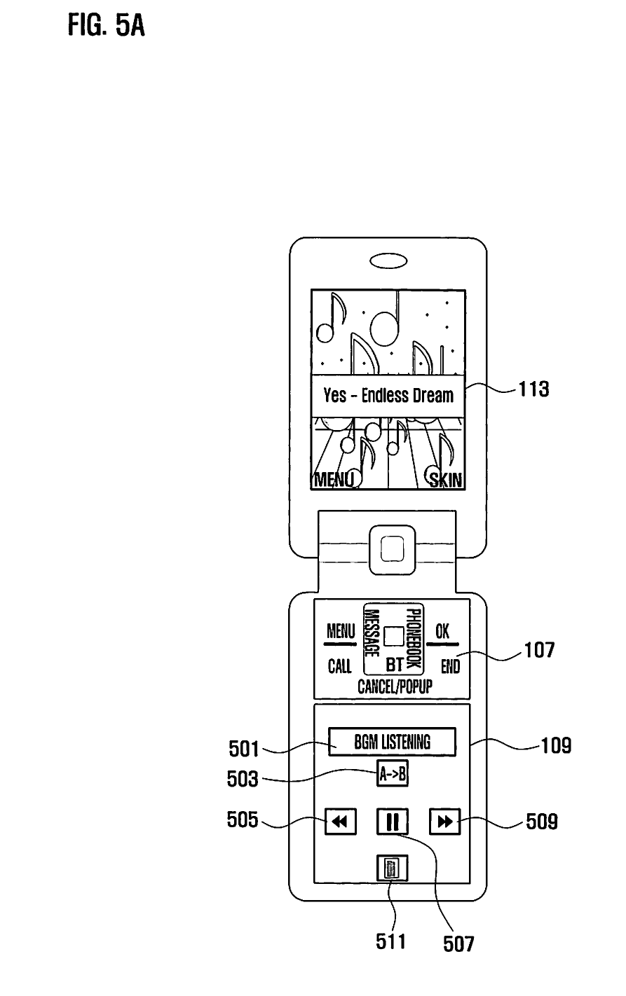

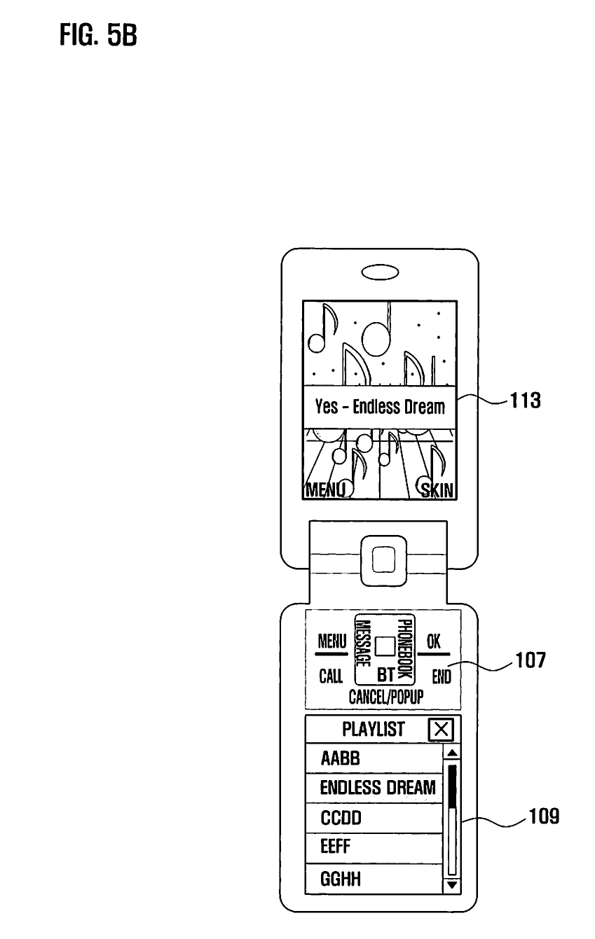

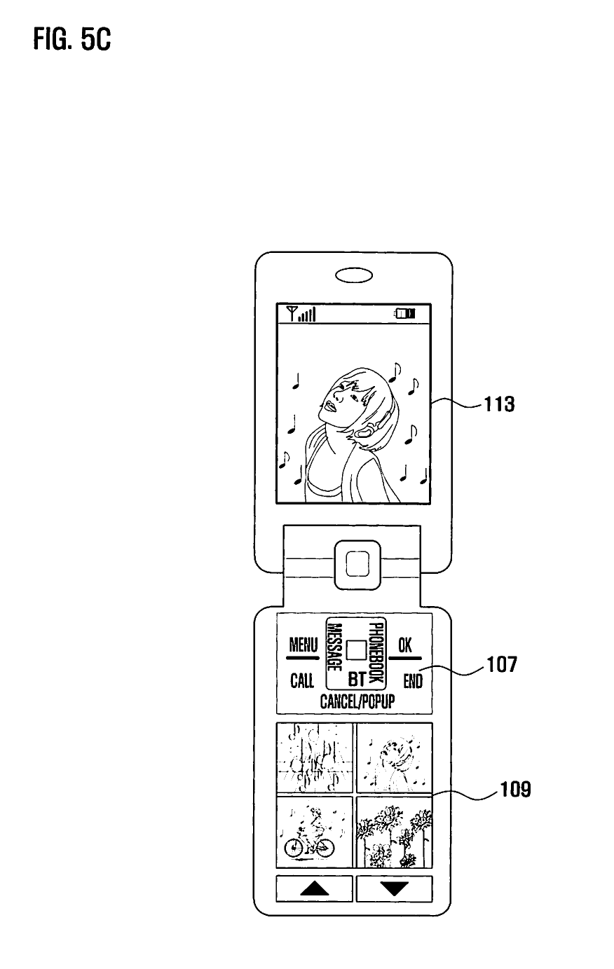

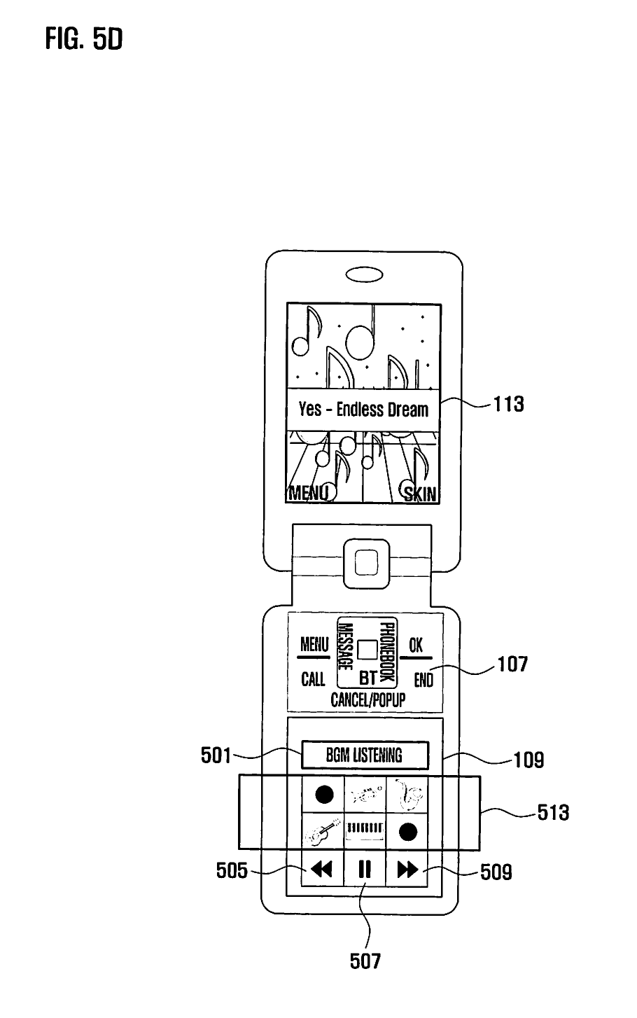

FIGS. 5A to 5D are display representations for a music play menu in the mobile terminal of FIG. 1.

FIG. 5A illustrates a music play state. The display unit 113 displays a preset background effect, title of currently played music, and sliding progress bar. The touch screen 109 displays play control keys such as a ‘sound effect’ key 501 for sound effect insertion, ‘section repeat’ key 503, ‘previous’ key 505, ‘pause’ key 507, ‘next’ key 509, and ‘playlist’ key 511 for displaying a list of music data stored in the memory unit 111.

When the user selects the ‘playlist’ key 511 in FIG. 5A, a list of music data is displayed on the touch screen 109 as in FIG. 5B. When the user selects the ‘OK’ key, which is a soft key and currently linked to the ‘SKIN’ object in the display unit 113, available background effects are displayed on the touch screen 109 as in FIG. 5C. Thereafter, a selected background effect is displayed on the display unit 113.

When the user selects the ‘sound effect’ key 501 in FIG. 5A, musical instrument images 513 are displayed on the touch screen 109 as in FIG. 5D. Keys 505, 507, 509 for selecting a musical instrument image 513 are displayed at the lower end of the touch screen 109. When a musical instrument image 513 is selected, the control unit 103 extracts a music tone corresponding to the selected musical instrument image from a database table stored in the memory unit 111, and controls the audio unit 115 to output the extracted music tone through the speaker SPK together with music data being played.

As apparent from the above description, the present invention provides a touch screen-enabled mobile terminal and function display method for the same, wherein a display unit and a touch screen are operated together, enabling a dual display feature. As a result, the user can use various functions of the mobile terminal such as message handling and music listening in a more convenient manner with a reduced number of inputs.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A function display method for a mobile terminal having a touch screen as an input/output means, the method comprising:
selecting a menu of the mobile terminal; and
displaying a user interface window corresponding to the selected menu on the touch screen.

2. The function display method of claim 1, wherein displaying a user interface window comprises:
displaying, when the selected menu is a message viewing menu, message details of a message selected from the message viewing menu and a user interface window for message handling on the touch screen;
displaying, when the selected menu is a music play menu, a user interface window for playing, selecting, and editing music data on the touch screen; and
displaying, when the selected menu is a text input menu, a user interface window for inputting alphanumeric information on the touch screen.

3. The function display method of claim 2, wherein the user interface window for message handling is a window having message handling keys including at least one of a ‘reply’ key, a ‘forward’ key, a ‘delete’ key, a ‘save’ key, and a ‘protect’ key.

4. The function display method of claim 3, wherein the message details comprise message contents, date and time of transmission/reception, and sender/recipient phone number.

5. The function display method of claim 2, wherein the user interface window for playing, selecting, and editing music data is a window having play control keys including at least one of a ‘playlist’ key, a ‘pause/play’ key, a ‘previous’ key, a ‘next’ key, a ‘section repeat’ key, and a ‘sound effect’ key.

6. The function display method of claim 5, further comprising displaying, when the selected menu is a music play menu, a preset background effect on a display unit together with music playing.

7. The function display method of claim 6, wherein displaying a preset background effect further comprises:
checking whether a background effect change signal is input;
displaying, when a background effect change signal is input, a list of available background effects on the touch screen; and
displaying a background effect newly selected from the list instead of the preset background effect.

8. The function display method of claim 5, further comprising:
displaying, when the ‘sound effect’ key is input, images of musical instruments available for sound effects; and
extracting a music tone corresponding to a musical instrument image selected from the displayed images of musical instruments, and outputting the extracted music tone together with music data being played.

9. The function display method of claim 5, further comprising:
displaying, when the ‘playlist’ key is input, a list of available music data; and
playing music data newly selected from the list instead of the preset music data being played.

10. A mobile terminal comprising:
a memory unit for storing at least one user interface window;
an input unit, comprising a touch screen, for selecting a menu of the mobile terminal; and
a control unit for extracting a user interface window corresponding to the selected menu from the memory unit, and displaying the extracted user interface window on the touch screen.

11. The mobile terminal of claim 10, wherein when the selected menu is a message viewing menu, the control unit displays message details of a message selected from the message viewing menu and a user interface window for message handling on the touch screen.

12. The mobile terminal of claim 11, wherein the user interface window for message handling is a window having message handling keys including at least one of a ‘reply’ key, a ‘forward’ key, a ‘delete’ key, a ‘save’ key, and a ‘protect’ key.

13. The mobile terminal of claim 10, wherein when the selected menu is a music play menu, the control unit displays a user interface window for playing, selecting, and editing music data on the touch screen.

14. The mobile terminal of claim 13, wherein the user interface window for playing, selecting, and editing music data is a window having play control keys including a ‘playlist’ key, a ‘pause/play’ key, a ‘previous’ key, a ‘next’ key, a ‘section repeat’ key, and a ‘sound effect’ key.

15. The mobile terminal of claim 14, wherein when the ‘sound effect’ key is input, the control unit displays images of musical instruments available for sound effects on the touch screen.

16. The mobile terminal of claim 10, wherein when the selected menu is a text input menu, the control unit displays a user interface window for inputting alphanumeric information on the touch screen.
